(19) United States
(12) Patent Application Publication
(10) Pub. No.: US 2014/0186523 A1
(43) Pub. Date: Jul. 3, 2014

(54) SLOT DIE COATING APPARATUS AND METHOD FOR MANUFACTURING MEMBRANE ELECTRODE ASSEMBLY

(71) Applicant: HYUNDAI MOTOR COMPANY, Seoul (KR)

(72) Inventors: Jae Seung Lee, Yongin (KR); Yong Min Kim, Seongnam (KR); Ji Seok Hwang, Yongin (KR)

(73) Assignee: HYUNDAI MOTOR COMPANY, Seoul (KR)

(21) Appl. No.: 13/859,955

(22) Filed: Apr. 10, 2013

(30) Foreign Application Priority Data
Dec. 28, 2012 (KR) 10-2012-0156297

(51) Int. Cl. H01M 4/88

(52) U.S. Cl. CPC H01M 4/8828
USPC 427/115; 118/300

(57) ABSTRACT

Disclosed herein is a slot die coating apparatus and method for manufacturing a membrane electrode assembly. The apparatus is configured to discharge a mixture of a plurality of different types of catalytic slurries, to coat portions of an electrode with the different types of catalytic slurries. The apparatus includes a slot die coater head that is configured to receive different types of catalytic slurries and discharge a mixture of the catalytic slurries. In addition, the apparatus includes a catalytic slurry module that is configured to supply the different types of catalytic slurries to the slot die coater head.

### CROSS-REFERENCE TO RELATED APPLICATION

This application claims under 35 U.S.C. §119(a) the benefit of Korean Patent Application No. 1020120156297 filed on Dec. 28, 2012, the entire contents of which are incorporated herein by reference.

### BACKGROUND

(a) Technical Field

The present invention relates to a slot die coating apparatus for manufacturing a membrane electrode assembly, and more particularly, a slot die coating apparatus for manufacturing an MEA (membrane electrode assembly) which can mix and coat different types of catalytic slurries for each part of an electrode when coating release paper with a catalytic slurry.

(b) Background Art

In general, an MEA (Membrane Electrode Assembly) used for fuel cell systems is manufactured, as shown in FIG. 1, by coating a release paper with a catalytic slurry, making an assembly with a macromolecular membrane, the release paper, and a catalytic layer mixed by transferring the release paper coated with the catalytic slurry, removing the release paper from the assembly, and bonding the assembly with a gas diffusion layer. The manufacturing method is generally used because an electrode can be easily coated as desired in various ways and manufactured in a mass quantities.

There are several methods of coating release paper with an electrode catalytic slurry such as bar coating, comma coating, slot die coating, gravure coating, and spray coating.

The bar coating or the spray coating is a method used for manufacturing a substantially small amount of electrodes. In addition, in the comma coating and the gravure coating it may be difficult to control the dimension of an electrode and the property of a catalytic slurry may change, thus the methods are not generally used for mass production.

On the contrary, the slot die coating is capable of controlling the dimension of an electrode and coating a catalytic slurry in a closed circuit system, thus, the ingredient of the catalytic slurry may be maintained without substantial change; therefore, slot die coating is generally used for the apparatuses that coat a release paper with an electrode catalytic slurry. However, the slot die coating apparatus of the related art is only capable of coating release paper with one type of catalytic slurry.

In other words, a slot die coating apparatus of the related art, as shown in FIGS. 2 to 4, includes: a slot die coater head 4 configured to discharge a catalytic slurry 3 onto the surface of release paper wound on a coating roll 1; a supply line 5 connected to supply a catalytic slurry to the slot die coater head 4; an outlet valve 6 disposed in the supply line 5 and configured to open/close to supply and block a catalytic slurry to the slot die coater head 4; a return line 7 connected with the supply line 5 to return a catalytic slurry to a storage tank; and a return valve 8 disposed in the return line 7 and configured to open/close the return line 7.

Further, the slot die coater head 4 includes an inlet passageway 4a connected with the supply line 5, a cavity 4b connected with the inlet passageway 4a and configured to store a catalytic slurry, and an outlet port 4c connected with the cavity 4b and configured to discharge a catalytic slurry 3.

Therefore, the slot die coating apparatus includes one supply line 5 configured to supply a catalytic slurry to the slot die coater head 4 and the slot die coater head 4 includes one inlet passageway 4a to receive a catalytic slurry, accordingly the slot die coater head 4 receives only one type of catalytic slurry through one supply line 5 and may coat release paper with the catalytic slurry. Thus, the slot die coating may not be used to coat various types of catalytic slurries on different parts of an electrode.

For reference, a membrane electrode assembly shows different deteriorations on the parts due to the amount of water being different for positions of the electrode and the pressure and temperature of a gas being different in operation of a fuel cell, then the portions with substantially large deterioration damage the electrode affecting the portions without deterioration and causing the portions to be unusable, thus reducing performance of the entire fuel cell system, which causes the entire system to stop.

Therefore, a high durability catalytic (e.g., alloy catalytic or high durability carrier catalytic) slurry or a substantially large amount of catalyst may be used to coat the portions with large deterioration for the parts of an electrode, and thus, it may be necessary to coat a mixture of different types of catalytic slurries, however the slot die coating apparatus of the related art may only coat with one type of catalytic slurry.

Further, buildup of droplets of water around a hydrogen exhaust port may occur due to insufficient discharging of water and water build up may also occur around the lower end portion of a membrane electrode assembly, thus an electrode with substantially high water repellency is required. Thus, the catalytic slurry may be coated with binders or with a water repellent for each part of the electrode.

The description provided above as a related art of the present invention is just for helping understanding the background of the present invention and should not be construed as being included in the related art known by those skilled in the art.

### SUMMARY

The present invention provides a slot die coating apparatus for manufacturing a membrane electrode assembly that may improve durability of an electrode and coat a mixture of different types of catalytic slurries for each part of an electrode, and may improve performance of a fuel cell system through the improvement of durability of an electrode.

Specifically, the present invention provides a slot die coating apparatus for manufacturing a membrane electrode assembly, including: a slot die coater head configured to receive one or more different types of catalytic slurries and discharge a mixture of the catalytic slurries; and a catalytic slurry module configured to supply one or more different catalytic slurries to the slot die coater head.

The slot die coater head may include: a plurality of inlet passageways formed to receive different types of catalytic slurries; a cavity divided into a plurality of chambers connected with the inlet passageways, respectively, by a separator, and configured to store catalytic slurries; and an outlet port connecting the divided chambers with one passageway to allow different types of catalytic slurries to be mixed and discharged.

The catalytic slurry supply module may include: a plurality of supply lines connected with the divided chambers, respectively, to supply different types of catalytic slurries; and outlet valves disposed in the supply lines, respectively, and to open/close to supply and block catalytic slurries to the chambers.

The apparatus may further include: return lines connected with the supply lines, respectively, and configured to return the catalytic slurries to storage tanks; and return valves disposed in the return lines, respectively, and configured to open/close the return lines. The storage tanks connected with the return lines may be separated.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary view illustrating a method of manufacturing a membrane electrode assembly according to the related art;

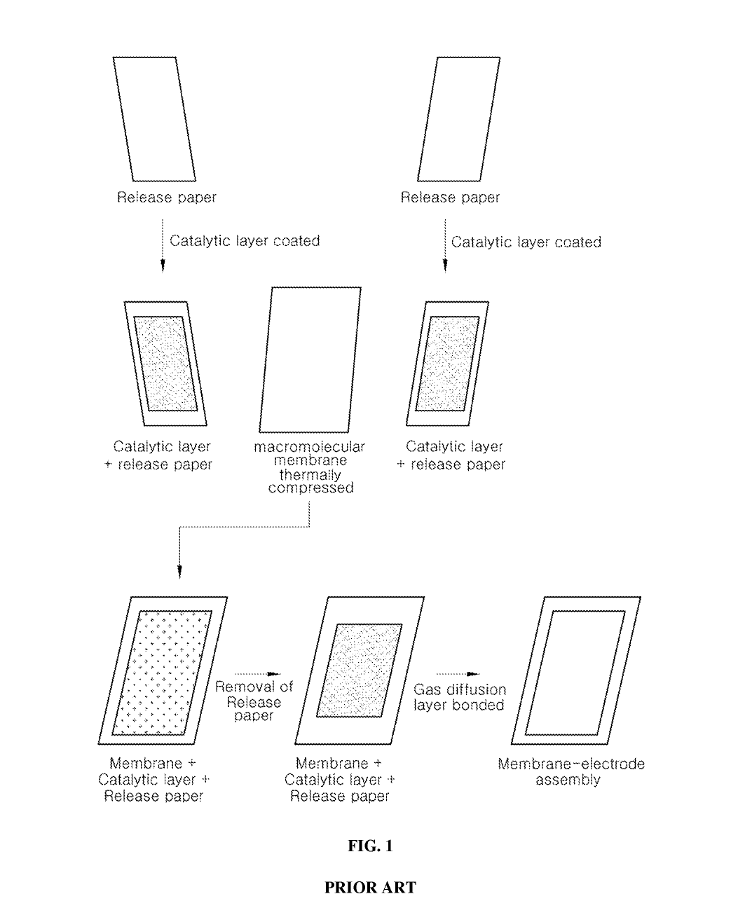

FIG. 2 is an exemplary view illustrating a slot die coating assembly for manufacturing a membrane electrode assembly according to the related art;

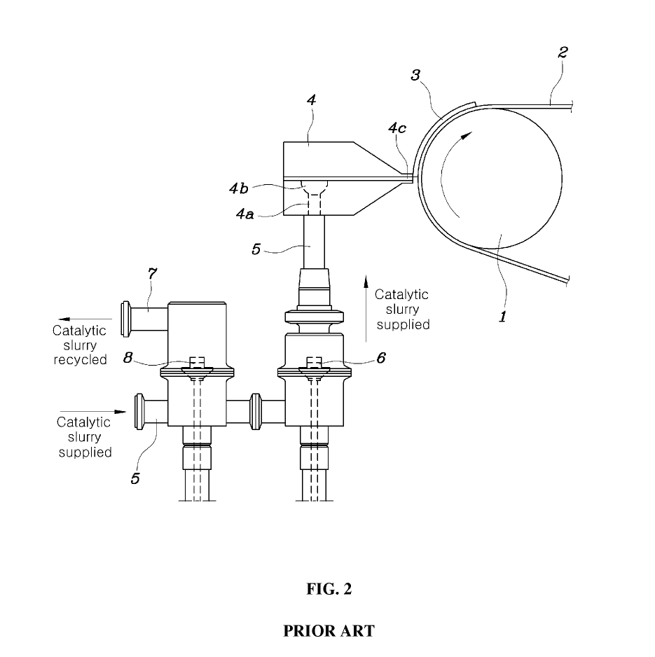

FIG. 3 is an exemplary schematic view of FIG. 2 according to the related art;

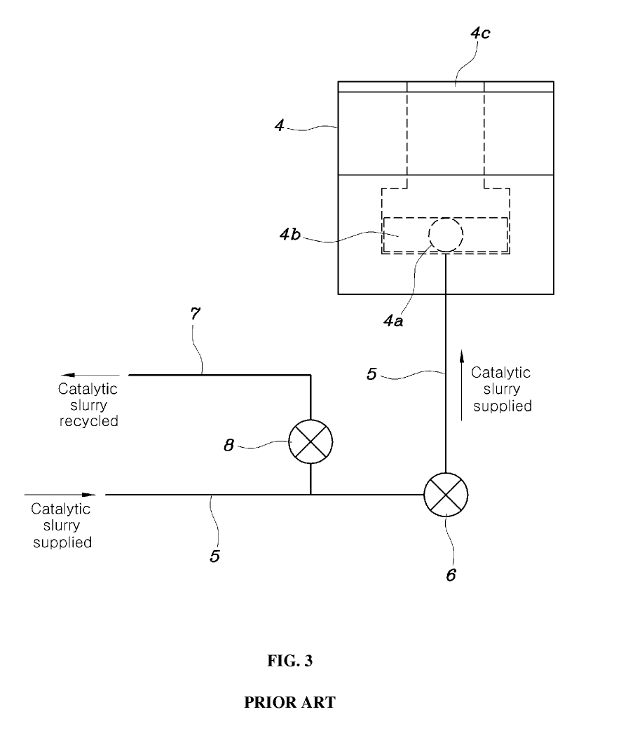

FIG. 4 shows exemplary views of a slot die coater head according to the related art;

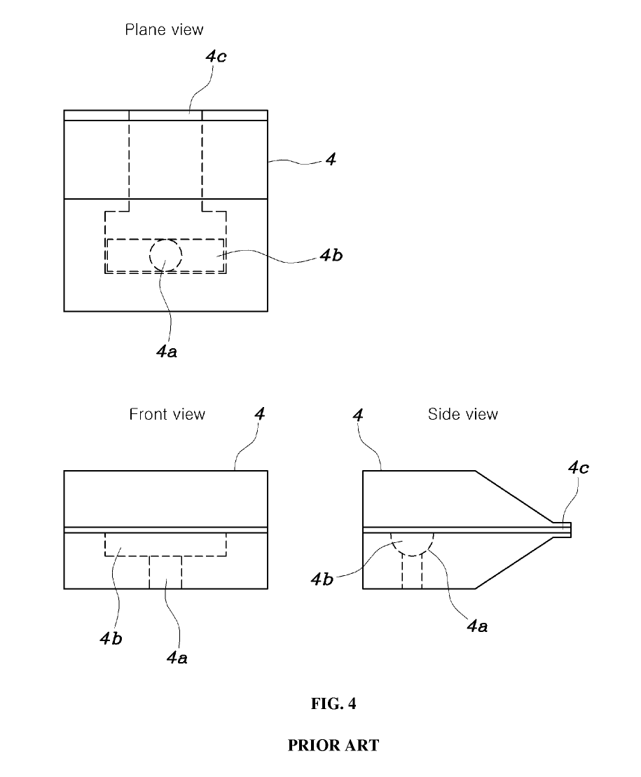

FIG. 5 is an exemplary schematic view of a slot die coating apparatus according to an exemplary embodiment of the present invention; and

FIG. 6 shows exemplary views of a slot die coater head according to an exemplary embodiment of the present invention.

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

A slot die coating apparatus for manufacturing a membrane electrode assembly according to exemplary embodiments of the present invention is described hereafter in detail with reference to the accompanying drawings.

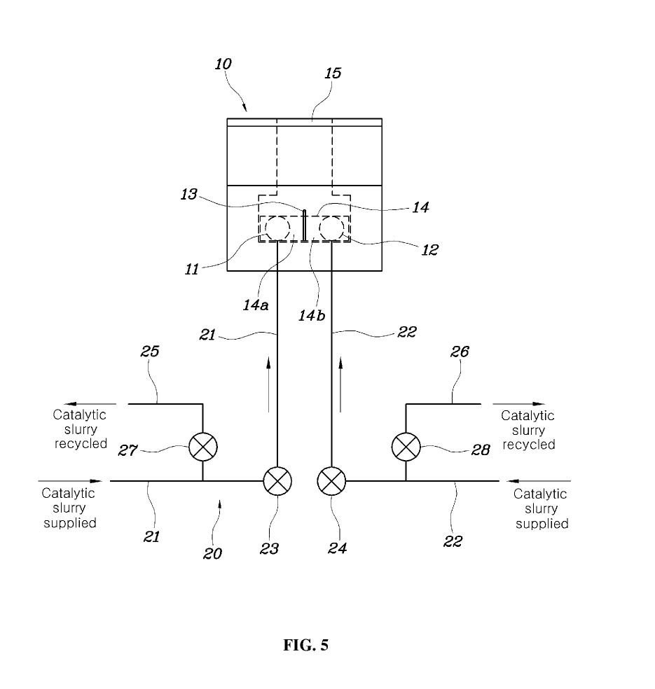

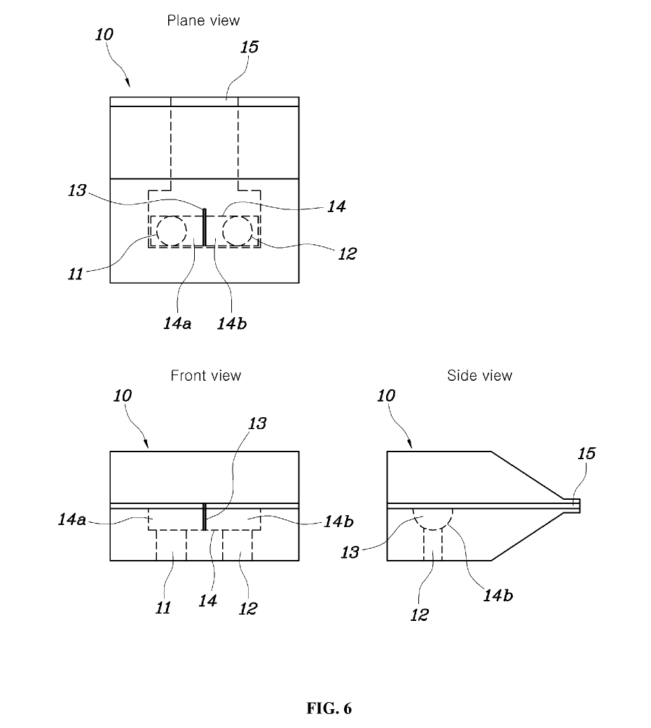

A slot die coating apparatus according to the present invention is an apparatus for coating release paper with a catalytic slurry when manufacturing an MEA (Membrane Electrode Assembly) that is used for a fuel cell system and may be configured to mix and coat one or more different types of catalytic slurries. In other words, the slot die coating apparatus for manufacturing a membrane electrode assembly, as shown in FIGS. 5 to 6, may include: a slot die coater head 10 configured to receive one or more different types of catalytic slurries and discharge a mixture of the catalytic slurries; and a catalytic slurry supply module 20 configured to supply one or more different types of catalytic slurries to the slot die coater head 10.

The slot die coater head 10 may include: a plurality of inlet passageways 11 and 12 formed to receive different types of catalytic slurries; a cavity 14 divided into a plurality of chambers 14a and 14b connected with the inlet passageways 11 and 12, respectively, by a separator 13, and may be configured to store catalytic slurries; and an outlet port 15 connecting the divided chambers 14a and 14b with one passageway to allow different types of catalytic slurries to be mixed and discharged.

Further, the catalytic slurry module 20 may include: a plurality of supply lines 21 and 22 connected with the divided chambers 14a and 14b, respectively, to supply different types of catalytic slurries; outlet valves 23 and 24 disposed in the supply lines 21 and 22, respectively, and configured to open/close to supply and block catalytic slurries to the chambers 14a and 14b; return lines 25 and 26 connected with the supply lines 21 and 22, respectively, and configured to return the mixed catalytic slurries to storage tanks; and return valves 27 and 28 disposed in the return lines 25 and 26, respectively, and configured to open/close the return lines 25 and 26. The storage tanks connected with the return lines 25 and 26 may be separated.

Therefore, according to an exemplary embodiment of the present invention, it may be possible to control supply and blocking of catalytic slurries to the slot die coater head 10 by simultaneously opening/closing the outlet valves 23 and 24 and simultaneously opening/closing the return valves 27 and 28.

Further, according to an exemplary embodiment of the present invention, it may be possible to supply a plurality of different types of catalytic slurries to the slot die coater head 10 and the slot die coater head 10 may mix different types of catalytic slurries and discharge the mixture to release paper. Thus, an electrode may be coated with different catalytic slurries on portions of the electrodes using the apparatus of the present invention. In other words, it may be possible to mix and coat high-durability catalytic (e.g., alloy catalytic or high-durability carrier catalytic) slurries to prevent deterioration of a catalyst on portion with substantially large deterioration for each part of the electrode.

Further, it may be possible to coat a portion where droplets may build up such as the lower end portion of a membrane electrode assembly or a hydrogen exhaust port, with a mixture of catalytic slurries containing a water repellent to increase water repellency of an electrode.

As different types of catalytic slurries are coated on portions of an electrode, durability of the electrode may be improved, thus it may be possible to improve performance and increase lifespan of a fuel cell system and the degree of freedom in a driving control technique of a fuel cell vehicle may increase.

According to a slot die coating apparatus for manufacturing a membrane electrode assembly of the present invention, it may be possible to discharge a mixture of one or more different types of catalytic slurries, thus it may be possible to coat portions of an electrode with different types of catalytic slurries, and accordingly, it may be possible to improve durability of the electrode, thereby increasing the performance and lifespan of a fuel cell system.

The invention has been described in detail with reference to exemplary embodiments thereof. However, it will be appreciated by those skilled in the art that changes may be made in these embodiments without departing from the principles and spirit of the invention, the scope of which is defined in the accompanying claims and their equivalents.

What is claimed is:

1. A slot die coating apparatus for manufacturing a membrane electrode assembly comprising:
a slot die coater head configured to receive a plurality of different types of catalytic slurries and discharge a mixture of the catalytic slurries; and
a catalytic slurry module configured to supply the plurality of different types of catalytic slurries to the slot die coater head.

2. The apparatus of claim 1, wherein the slot die coater head includes:
a plurality of inlet passageways formed to receive the plurality of different types of catalytic slurries;
a cavity divided into a plurality of chambers connected with the inlet passageways, respectively, by a separator, and configured to store the catalytic slurries; and
an outlet port connecting the divided chambers with one passageway to allow that the plurality of different types of catalytic slurries to be mixed and discharged.

3. The apparatus of claim 2, wherein the catalytic slurry supply module includes:
a plurality of supply lines connected with the divided chambers, respectively, to supply the plurality of different types of catalytic slurries; and
a plurality of outlet valves disposed in the supply lines, respectively, and configured to open and close to supply and block catalytic slurries to the chambers.

4. The apparatus of claim 3, further comprising:
a plurality of return lines connected with the supply lines, respectively, and configured to return the mixed catalytic slurries to storage tanks; and
a plurality of return valves disposed in the plurality of return lines, respectively, and configured to open the plurality of return lines.

5. The apparatus of claim 4, wherein the storage tanks connected with the return lines are separated.

6. A method for slot die coating, comprising:
receiving, at a slot die coater head, a plurality of different types of catalytic slurries;
mixing, the plurality of different types of catalytic slurries;
discharging, by the slot die coater, the mixture of the plurality of different types of catalytic slurries; and
supplying, by a catalytic slurry module, the mixture of the plurality of different types of catalytic slurries to the slot die coater head.

7. The method of claim 7, further comprising:
receiving at a plurality of inlet passageways, the plurality of different types of catalytic slurries;
storing the plurality of different types of catalytic slurries within a cavity divided into a plurality of chambers each connected with at least one of the plurality of inlet passageways, respectively; and
wherein the mixture of the plurality of different types of catalytic slurries is discharged through an outlet port connecting the divided chambers with one passageway.

8. The method of claim 7, further comprising:
supply the plurality of different types of catalytic slurries by a plurality of supply lines connected with the divided chambers, respectively; and
opening and closing a plurality of outlet valves disposed in the supply lines, respectively, to supply and block catalytic slurries to the chambers.

9. The method of claim 8, further comprising:
returning the mixture of the plurality of different types of catalytic slurries to storage tanks via a plurality of return lines connected with the supply lines, respectively; and
opening the plurality of return lines using a plurality of return valves disposed in the plurality of return lines, respectively.
